(19) United States
(12) Patent Application Publication
(10) Pub. No.: US 2022/0012289 A1
(43) Pub. Date: Jan. 13, 2022

(54) SYSTEMS, APPARATUS, AND METHODS OF USING A SELF-AUTOMATED MAP TO AUTOMATICALLY GENERATE A QUERY RESPONSE

(71) Applicant: Remi Muinatu IBRAHEEM, Gloucester, MA (US)

(72) Inventor: Remi Muinatu IBRAHEEM, Gloucester, MA (US)

(21) Appl. No.: 17/482,180

(22) Filed: Sep. 22, 2021

Related U.S. Application Data
(63) Continuation-in-part of application No. 15/668,846, filed on Aug. 4, 2017, now abandoned.
(60) Provisional application No. 62/371,542, filed on Aug. 5, 2016.

(51) Int. Cl. G06F 16/9038; G06K 9/62; G06K 9/00; G06F 16/903; G06F 3/16; G10L 15/22; G06N 20/00

(52) U.S. Cl. CPC G06F 16/9038; G06K 9/6263; G06K 9/00335; G10L 2015/223; G06F 3/167; G10L 15/22; G06N 20/00; G06F 16/90335

(57) ABSTRACT

A method includes receiving, at a processor and via a graphical user interface (GUI), input data including a representation of at least one behavioral pattern. The at least one behavioral pattern is correlated to pattern data associated with a subset of detectors from a set of detectors. A first matrix is generated for a first point in time based on the correlation. Interactive objects are generated for presentation via the GUI, and each is associated with the set of detectors from the plurality of detectors. In response to detecting a user interaction with at least one of the interactive objects a relationship between each detector from the set of detectors in the first matrix and the input data is defined and stored. The first matrix is transformed based on the relationship, and the transformed matrix is synthesized to generate a motif of the behavioral pattern of the input data.

### CROSS-REFERENCE TO RELATED APPLICATIONS

This application is a Continuation-in-Part of U.S. patent application Ser. No. 15/668,846, filed Aug. 4, 2017 and titled “Systems, Apparatus, and Methods for Applying Astrology,” which claims the priority benefit, under 35 U.S.C. § 119(e), of U.S. Provisional Patent Application No. 62/371,542, filed Aug. 5, 2016 and titled “Systems Apparatus and Methods for Applying Astrology,” the disclosures of each of which are incorporated by reference herein in their entireties for all purposes.

### BACKGROUND

It is well known that the positions of the stars and planets can have an influence on events and on the lives and behavior of people. Conventionally, studying such influence of stars and planets have enabled predictions to be made of a future of a person. However, merely analyzing the positions of the stars and planets for an entity (e.g., person, object, location, etc.) does not provide an understanding of the interactions that the entity can have with the outside world (e.g., other entities) and how these interactions may in fact influence the future of the entity. Therefore, predictions made from mere analysis of the positions of stars and planets are often isolated predictions. More specifically, such predictions can be isolated from the influence of other entities, and therefore, can be incomplete and often inaccurate.

Additionally, there is no existing technology that can provide real-time on-demand predictions and responses to queries from a user. In particular, there is no existing technology that can provide real-time on-demand responses to queries from a user about the future of one or more entities. Accordingly, there is an unmet need for a sophisticated technology that can provide complete, accurate, and real-time predictions to a user on demand.

### SUMMARY

In some embodiments, a method includes receiving, at a processor and via a graphical user interface (GUI), input data including a representation of at least one behavioral pattern. The at least one behavioral pattern is correlated to pattern data associated with a subset of detectors from a set of detectors. A first matrix including at least the set of detectors is generated for a first point in time based on the correlation. Interactive objects are generated for presentation via the GUI, and each is associated with the set of detectors from the plurality of detectors. In response to detecting a user interaction with at least one of the interactive objects a relationship between each detector from the set of detectors in the first matrix and the input data is defined and stored. The first matrix is transformed based on the relationship, and the transformed matrix is synthesized to generate a motif of the behavioral pattern of the input data.

In some embodiments, a method of automatically generating a query response to a query from a user includes receiving, at a processor, a representation of a voice command including user data detected via a microphone. The voice command is associated with a user. In response to the user data, the processor generates a first matrix that correlates a location for a first detector from a plurality of detectors at a first time with at least a portion of the user data. A representation of a query is received, at the processor and from the user, in response to at least one of a voice input or a visual input. Based at least in part on the query, a plurality of prompts is automatically generated via the processor, with each prompt from the plurality of prompts including one of a voice prompt or a visual prompt. The plurality of prompts is displayed to the user via at least one of a speaker or a graphical user interface (GUI). In response to detecting at least one user response to the plurality of prompts, a representation of a relationship between the first matrix and the at least the portion of the user data is stored, based at least in part on the at least one user response. The first matrix is then translated, thereby generating a query response to the query from the user. The query may, in turn, be displayed or otherwise presented to the user (requestor).

In some embodiments, a method for predicting future interaction between two entities includes receiving, at a processor, a representation of a voice command or a representation of a visual command including user data. The voice command or visual command is associated with a user, and the user data includes characteristics relating to a first entity. In response to the user data, the processor generates a first matrix that correlates a location for a first detector from a plurality of detectors at a first time with at least a portion of the user data, including characteristics relating to the first entity. First transits of the first detector from the plurality of detectors are calculated for a first time period, based at least in part on the first matrix, the first transits of the first detector being for the first entity. An association between the first transits of the first detector for the first entity and second transits of the first detector for a second entity is defined for the first time period. The second entity is associated with a second matrix that correlates the location for the first detector with characteristics relating to the second entity. An intelligence matrix is generated that associates the first transits of the first detector for the first entity with second transits of the first detector for the second entity. An interaction is predicted between the first entity and the second entity during the first time period based at least in part on the intelligence matrix.

### BRIEF DESCRIPTION OF THE DRAWINGS

FIG. 1 is a schematic of an example system for automatically generating query responses and/or for predicting interactions between different entities, in accordance with an embodiment.

FIG. 2 is a schematic description of an example host device, in accordance with an embodiment.

FIG. 3 is a flowchart illustrating a method of using a self-automated map to automatically generate a query response, in accordance with an embodiment.

FIG. 4 is a flowchart illustrating a method of automatically generating an intelligence matrix, in accordance with an embodiment.

### DETAILED DESCRIPTION

Systems and methods that can provide complete, accurate, and real time predictions to a user on demand is described herein. More specifically, the technology described herein can use a self-automated map and/or an intelligence matrix to automatically generate a query response for a user. The query response can include a prediction related to an entity (e.g., person, object, location, etc.). In some implementations, the prediction can include a possibility of interaction between two or more entities and/or the type of interaction between two or more entities. In some implementations, the predictions can include a motif of behavior for the entity.

As disclosed herein an “entity” can refer to a person, object, location (e.g., city, country, etc.), and/or the like. A “detector” can refer to data attributes associated with naturally occurring observable physical entities such as for example, a celestial body (e.g., planets, stars, asteroids, etc.). An “aspect” can refer to a characteristic associated with an entity such as for example, financial health, physical health, mental health, etc. A “matrix” can refer to an astrological chart such as a neonatal chart associated with an entity. “Translating a matrix” can refer to transforming an astrological chart of an entity to a modified chart and/or map that can associate patterns to detectors based on responses relating to the entity from the user, feedback relating to responses to query from the user, and/or the like. “Synthesizing a matrix” can refer to analyzing a matrix to extract information such as relationships, associations, correlations, etc. from a matrix. A “motif” can refer to visual patterns that can be represented as graphical representations such as images, visual illustrations, polygons, graphs, etc. that can be presented to a user. An “intelligence matrix” can refer to a representation of associations between the transit of a detector for a first entity and a transit of a detector for a second entity.

### Example System

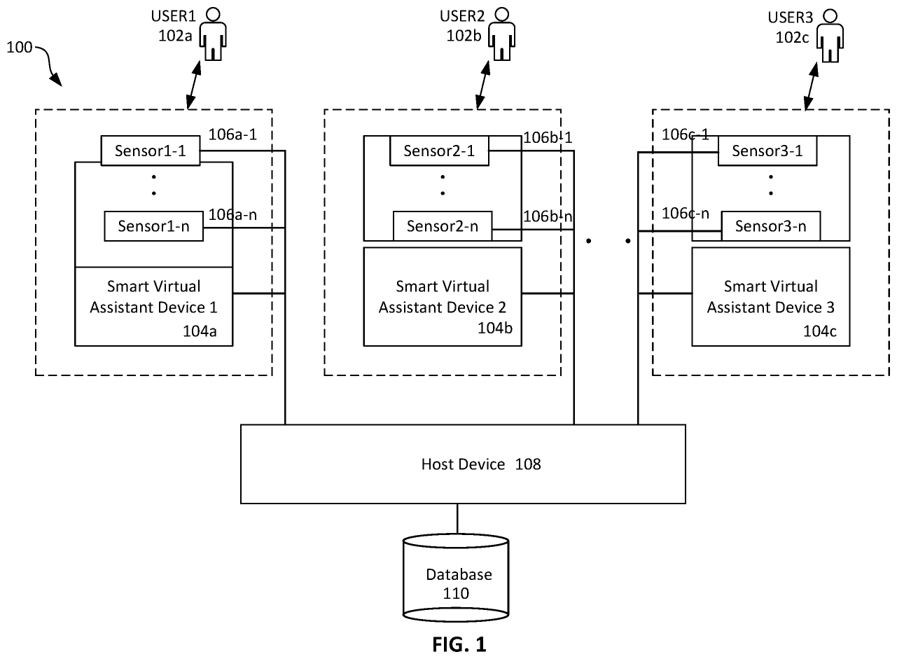

FIG. 1 is a schematic of an example system 100 for automatically generating query responses and/or for predicting interactions between different entities. Multiple users, for example, user1 102a, user2 102b, user3 102c, etc. (collectively referred to as user 102) can interact with the system 100. For example, each user 102 can interact with a smart virtual assistant device, for example, smart virtual assistant device1 104a, smart virtual assistant device2 104b, smart virtual assistant device3 104c, etc. (collectively referred to as smart virtual assistant device 104). The smart virtual assistant device 104 can include a mobile compute device, such as a smartphone, a tablet, a laptop computer, or any other suitable device as discussed below. The user 102 and/or the smart virtual assistant device 104 can include, be in contact with, or interact with (e.g., by virtue of being within close enough proximity to communicate wirelessly) one or more sensors, such as sensor1-1 106a-1, sensor 1-n 106a-n, sensor2-1 106b-1, sensor 2-n 106b-n, sensor3-1 106c-1, sensor 3-n 106c-n (collectively referred to as sensor 106). For example, user 102a and/or smart virtual assistant device 104a can include, be in contact with, or interact with sensor1-1 106a-1, sensor 1-n 106a-n, etc. Similarly, user 102b and/or smart virtual assistant device 104b can include, be in contact with, or interact with sensor2-1 106b-1, sensor 2-n 106b-n, etc. and user 102c and/or smart virtual assistant device 104c can include, be in contact with, or interact with sensor3-1 106c-1, sensor 3-n 106c-n, etc.

FIG. 1 illustrates each smart virtual assistant device 104 being co-located with two associated sensors 106, as an example configuration. It should be readily understood that each user and/or smart virtual assistant device can include, be in contact with, or interact with any number of sensors. Similarly, any number of users can interact with the system 100 through any number of virtual assistant devices 104 (e.g., via graphical user interfaces (GUIs) thereof).

The sensors 106 and the smart virtual assistant devices 104 can be operably/communicably coupled to a host device 108 via a network (not shown in FIG. 1). The host device 108 can be implemented in hardware (e.g., a server) and/or software. The host device 108 can be operably/communicably coupled to a database 110.

In some implementations, the smart virtual assistant device 104 can be a compute device capable of receiving voice commands and/or visual commands/“cues.” Some non-limiting examples of the smart virtual assistant device 104 include intelligent personal assistants (e.g., Google Assistant™, Amazon Alexa™, Amazon Echo™, Siri™, Blackberry Assistant™, etc.), computers (e.g., desktops, personal computers, laptops etc.), tablets and e-readers (e.g., Apple iPad®, Samsung Galaxy® Tab, Microsoft Surface®, Amazon Kindle®, etc.), mobile devices and smart phones (e.g., Apple iPhone®, Samsung Galaxy®, Google Pixel®, etc.), etc. In some implementations, the smart virtual assistant device 104 can include input components such as a microphone, a touchscreen interface, a keyboard, a mouse, a joystick, etc. In some implementations, the smart virtual assistant device 104 includes output components such as a graphical user interface, an on-screen keyboard (OSK), etc. In some implementations, the smart virtual assistant device 104 can convert voice commands into audio data such that the audio data is transmitted to the host device 108 for further analysis. In some implementations, the smart virtual assistant device 104 can convert visual commands into text and/or image data such that the text and/or image data is transmitted to the host device 108 for further analysis.

In some implementations, the smart virtual assistant device 104 can be configured to present interactive objects to the user 102 that the user 102 can interact with. For example, the smart virtual assistant device 104 can be configured to display interactive graphical objects (e.g., interactive prompts) on a graphical user interface. The user can interact with the interactive graphical objects to provide answers and/or feedback to the smart virtual assistant device 104. Similarly, the smart virtual assistant device 104 can be configured to present interactive audio prompts via a speaker to the user 102.

In some implementations, the sensors 106 can be any suitable sensor that can detect properties of, or gather information relating to, the user 102 and/or the environment surrounding the user 102 and/or the smart virtual assistant device 104. For example, the sensors 106 can collect image data of the environment surrounding the user 102 and/or the smart virtual assistant device 104. Put differently, the sensor 106 can be any suitable image sensor such as cameras, scanners, portable devices such as a handheld computer tablet, a smartphone with camera, or a digital camera, etc. In some implementations, the sensors 106 can detect and capture (i.e., record/store in memory) audio data of the environment surrounding the user 102 and/or the smart virtual assistant device 104. Put differently, the sensor 106 can be any suitable audio sensor such as speakers, acoustic pressure sensors, sound transducers, amplifiers, and/or portable devices with onboard speakers such as a handheld computer tablet, a smartphone with a camera, or a digital camera, etc. In some implementations, the sensors 106 can include a Global Positioning System (GPS) tracking device configured to determine, record, and/or transmit the location of the user 102 and/or the smart virtual assistant device 104.

The data associated with the sensors 106 and/or the smart virtual assistant device 104 can be transmitted to a host device 108 via a network (not shown in FIG. 1). The host device 108 and/or the sensors 106 and the smart virtual assistant device 104 on the network can be connected via one or more wired or wireless communication networks (not shown) to share resources such as, for example, data storage and/or computing power. The wired or wireless communication networks between host device 108 and/or the sensors 106 and the smart virtual assistant device 104 of the network can include one or more communication channels, for example, a radio frequency (RF) communication channel(s), a fiber optic commination channel(s), an electronic communication channel(s), and/or the like. The network can be and/or include, for example, the Internet, an intranet, a local area network (LAN), and/or the like.

In some implementations, the host device 108 can analyze the data received from the sensors 106 and/or the smart virtual assistant device 104. The host device 108 can analyze the received data to make predictions for the user, as discussed further below.

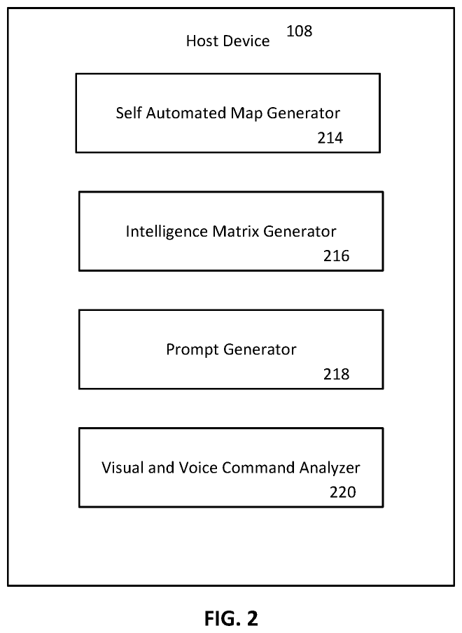

FIG. 2 is a schematic description of an example host device 108. In some implementation, the host device 108 can be configured to implement a self-automated map generator 214, an intelligence matrix generator 216, a prompt generator 218, and/or a visual and/or voice command analyzer 220. For example, the self-automated map generator 214, the intelligence matrix generator 216, the prompt generator 218, and the visual and/or voice command analyzer 220 can be modules (e.g., modules in a software code and/or stored in memory) that, when executed by a processor, are configured to perform a specific task (as further described below). These specific tasks can collectively enable the host device 108 to make complete and accurate predictions on demand. A non-limiting example of a module includes a function (e.g., one or more blocks of reusable code) designed to perform a specific task.

In such implementations, the self-automated map generator 214, the intelligence matrix generator 216, the prompt generator 218, and the visual and/or voice command analyzer 220 can be called in any suitable manner. For example, the host device 108 can include software code that when executed generates instructions to make complete and accurate predictions “on-demand” (i.e., in response to a request received from a user, for example via a GUI, voice command, etc.). The self-automated map generator 214, the intelligence matrix generator 216, the prompt generator 218, and the visual and/or voice command analyzer 220 can be functions within the software code. Additionally or alternatively, the software code can include one or more function calls (e.g., at least four function calls) that can invoke each of the self-automated map generator 214, the intelligence matrix generator 216, the prompt generator 218, and the visual and/or voice command analyzer 220 respectively. The function calls can redirect the processing performed by the host device 108 to the self-automated map generator 214, the intelligence matrix generator 216, the prompt generator 218, and the visual and/or voice command analyzer 220. Put differently, the host device 108 itself may include calls to the self-automated map generator 214, the intelligence matrix generator 216, the prompt generator 218, and the visual and/or voice command analyzer 220 and not necessarily the modules themselves. When calls to the self-automated map generator 214, the intelligence matrix generator 216, the prompt generator 218, and the visual and/or voice command analyzer 220 are invoked, the host device 108 can be configured to implement the specific tasks corresponding to the self-automated map generator 214, the intelligence matrix generator 216, the prompt generator 218, and the visual and/or voice command analyzer 220 respectively. Additionally or alternatively, the software code can include Application Programming Interfaces (API) which can interface with the self-automated map generator 214, the intelligence matrix generator 216, the prompt generator 218, and the visual and/or voice command analyzer 220.

In other implementations, the host device 108 can include the self-automated map generator 214, the intelligence matrix generator 216, the prompt generator 218, and the visual and/or voice command analyzer 220. In such implementations, each of the self-automated map generator 214, the intelligence matrix generator 216, the prompt generator 218, and the visual and/or voice command analyzer 220 can be suitable hardware components included in the host device 108. For example, each of the self-automated map generator 214, the intelligence matrix generator 216, the prompt generator 218, and the visual and/or voice command analyzer 220 can be individual processors configured to perform their respective specific tasks.

In some implementations, the visual and/or voice command analyzer 220 can analyze voice and/or visual inputs from the user. For example, the visual and/or voice command analyzer 220 can include a speech recognition module to recognize and translate spoken language by the user into text that can be used by the host device 108 for further analysis. The visual and/or voice command analyzer 220 can transform the voice and/or visual inputs into a suitable format understandable by processors to perform further analysis on the inputs. For example, a user 102 can interact with a smart virtual assistant device 104 to provide a voice and/or visual command as user input. The voice and/or visual command can be transmitted to the host device 108 via a network. The voice and/or visual command can include data that relates to a characteristic associated with an entity (e.g., person, object, place, etc.). For example, data can include a birth date, birth time, birth location and/or the like of a person. Additionally or alternatively, the data can include manufacturing date, manufacturing location and/or the like of an object. Similarly, the data can include geographical coordinates of a location. The visual and/or voice command analyzer 220 can analyze the voice and/or visual command to extract the data (e.g., birth date, birth time, birth location, manufacturing date, manufacturing location, geographical coordinates, etc.) for further analysis. In some implementations, the user 102 can interact with a smart virtual assistant device 104 to provide a voice and/or visual query. The visual and/or voice command analyzer 220 can analyze the query to determine what the request from the user.

In some implementations, the self-automated map generator 214 can automatically generate a query response. For instance, once the visual and/or voice command analyzer 220 extracts the data inputted from the user, the self-automated map generator 214 can generate a matrix that correlates a detector (e.g., planets, stars, and other celestial bodies) with at least a portion of the data. For example, the self-automated map generator 214 can generate a matrix that correlates various detectors to various aspects (e.g., financial health, mental health, physical health, career progression, etc.) of the entity based on the user input. It should be readily understood that the same detector may correlate to different aspects of different entities. For example, a first detector may correlate to financial health of a first entity but physical health of a second entity.

In some implementations, in response to receiving a query from the user, the prompt generator 218 can automatically generate prompts for the user to respond to. The prompts can be presented to the user via the smart virtual assistant device 104. For example, the prompts can be presented as interactive graphical objects on a graphical user interface. Additionally or alternatively, prompts can be presented as a speech output via a speaker. Once the user responds to these prompts, the self-automated map generator 214 can rate various aspects of the entity based on the user response. In some implementations, the self-automated map generator 214 can use the rating of the aspects to generate relationships between various detectors and aspects of the person. The self-automated map generator 214 can then translate the matrix, thereby generating a response to the user's query. For example, the self-automated map generator 214 can update the matrix based on the relationship between various detectors, the corresponding aspects, and their ratings. A response to the user's query can be generated based on the updated matrix. The response can be presented to the user via the smart virtual assistant device 104. For example, the response can be presented as interactive graphical objects on a graphical user interface. Additionally or alternatively, the response can be presented as a speech output via a speaker. In some implementations, the self-automated map generator 214 can further update the matrix based on feedback on the response to the user's query. Put differently, the self-automated map generator 214 can further update the matrix based on feedback from the users and/or the sensors.

In some implementations, the prompt generator 218 can generate prompts for the user to respond to. For example, the prompt generator 218 can automatically generate follow-up questions for the user. In some implementations, the prompt generator 218 can include and/or comprise a trained model (e.g., a machine learning model, neural network, stochastic model, probabilistic model, and/or the like) to automatically generate follow-up questions for the user in a dynamic (and, optionally, iterative) manner. In some implementations, the prompt generator can access a pre-determined set of questions stored in database 110. The follow-up questions can include questions relating to the behavior of the entity so far. These prompts can be provided as a voice prompt or a visual prompt. For instance, a speaker associated with the smart virtual assistant 104 can ask these questions verbally. Additionally or alternatively, a graphical user interface associated with the smart virtual assistant 104 device associated with the user 102 can display the questions for the user to answer. In some implementations, the prompt generator 218 can update the model based on feedback on the response to the user's query. For example, the model can be updated to generate additional questions for the user to respond to.

In some implementations, the intelligence matrix generator 216 can automatically generate an intelligence matrix that can predict a possibility of interaction between two or more entities and/or the type of interaction between two or more entities. In some implementations, the intelligence matrix generator 216 can predict a motif of behavior for an entity.

For example, once the visual and/or voice command analyzer 220 extracts the data input by the user, the intelligence matrix generator 216 can generate a matrix that correlates a detector (e.g., planets, stars, and other celestial bodies) with at least a portion of the data. For example, the intelligence matrix generator 216 can generate a matrix that correlates various detectors to various aspects (e.g., financial health, mental health, physical health, career progression, etc.) of the entity based on the user input. It should be readily understood that the same detector may correlate to different aspects of different entities. For example, a first detector may correlate to financial health of a first entity but physical health of a second entity.

In some implementations, the intelligence matrix generator 216 can time map the various detectors to various patterns. For instance, the intelligence matrix generator 216 can correlate the detectors to patterns for different time periods. In some implementations, the intelligence matrix generator 216 can calculate a first transit of a detector for the first entity for a given time duration based on the matrix. For example, each detector can transit through various detector locations as time passes by. The matrix can be used to locate a position of the detector. Accordingly, the intelligence matrix generator 216 can calculate the transit of the detector for a given time duration based on the matrix.

In some implementations, the intelligence matrix generator 216 can automatically associate the transit of the detector for the first entity with that of a transit of the detector for a second entity. For example, the second entity can have another matrix that correlates various detectors to various aspects of the entity. In some implementations, the same detector correspond to the same aspect for the first entity and for the second entity. Alternatively, the same detector can correspond to different aspects for the first entity and for the second entity. The same detector can be in different positions in the matrix for the first entity (e.g., first person) and the matrix for the second entity (e.g., second person). Accordingly, for a given time duration, the transit of the same detector can be different for the first person and for the second person. For the given time duration, the transits of the detector for the first person and the transits of the detector for the second person can be associated by intelligence matrix generator 216.

In some implementations, the intelligence matrix generator 216 can generate an intelligence matrix based on this association. The intelligence matrix can include a representation of association between the transit of the detector for the first entity and the transit of the detector for the second entity.

The intelligence matrix generator 216 can automatically predict whether an interaction is possible between the first entity and the second entity from the intelligence matrix. If the interaction is possible, the intelligence matrix generator 216 can predict the nature of the interaction and how such interaction may affect the first entity and/or the second entity. In some implementations, the intelligence matrix generator can predict a motif of behavioral pattern for an entity based on the intelligence matrix. These predictions (e.g., possibility of interaction, type of interaction, motif, etc.) can be presented to the user via the smart virtual assistant device 104. For example, predictions can be presented as interactive graphical objects on a graphical user interface. Additionally or alternatively, predictions can be presented as a speech output via a speaker. In some implementations, the intelligence matrix generator 216 can update the intelligence matrix based on feedback from the users, sensors, and/or the self-automated map generator 214.

Referring back to FIG. 1, the host device 108 can include a processor, a memory, and a communications interface. In some embodiments, the host device 108 can include one or more servers and/or one or more processors running on a cloud platform (e.g., Microsoft Azure®, Amazon® web services, IBM® cloud computing, etc.). Generally, the host device 108 (e.g., including a CPU) described herein may process data and/or user input to make predictions about the future. The host device 108 may be configured to receive, process, compile, compute, store, access, read, write, and/or transmit data and/or other signals. In some embodiments, the host device 108 can be configured to access or receive data and/or other signals from one or more of a sensor and a storage medium (e.g., memory, flash drive, memory card). In some embodiments, the host device 108 can be any suitable processing device such as processor configured to run and/or execute a set of instructions or code and may include one or more data processors, image processors, graphics processing units (GPU), physics processing units, digital signal processors (DSP), analog signal processors, mixed-signal processors, machine learning processors, deep learning processors, finite state machines (FSM), compression processors (e.g., data compression to reduce data rate and/or memory requirements), encryption processors (e.g., for secure wireless data and/or power transfer), and/or central processing units (CPU). The processor can be, for example, a general-purpose processor, Field Programmable Gate Array (FPGA), an Application Specific Integrated Circuit (ASIC), a processor board, and/or the like. The processor can be configured to run and/or execute application processes and/or other modules, processes and/or functions associated with the system 100. The underlying device technologies may be provided in a variety of component types (e.g., metal-oxide semiconductor field-effect transistor (MOSFET) technologies like complementary metal-oxide semiconductor (CMOS), bipolar technologies like generative adversarial network (GAN), polymer technologies (e.g., silicon-conjugated polymer and metal-conjugated polymer-metal structures), mixed analog and digital, and/or the like.

The systems and/or methods described herein may be performed by software (executed on hardware), hardware, or a combination thereof. Hardware modules may include, for example, a general-purpose processor (or microprocessor or microcontroller), a field programmable gate array (FPGA), and/or an application specific integrated circuit (ASIC). Software modules (executed on hardware) may be expressed in a variety of software languages (e.g., computer code), including C, C++, Java®, Python, Ruby, Visual Basic®, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

In some embodiments, the host device 108 can comprise a memory configured to store data and/or information. In some embodiments, the memory can comprise one or more of a random access memory (RAM), static RAM (SRAM), dynamic RAM (DRAM), a memory buffer, an erasable programmable read-only memory (EPROM), an electrically erasable read-only memory (EEPROM), a read-only memory (ROM), flash memory, volatile memory, non-volatile memory, combinations thereof, and the like. In some embodiments, the memory can store instructions to cause the processor to execute modules, processes, and/or functions associated with the system 100, such as self-automated map generator, intelligence matrix generator, prompt generator, visual and voice command analyzer. Some embodiments described herein can relate to a computer storage product with a non-transitory computer-readable medium (also may be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also may be referred to as code or algorithm) can be those designed and constructed for the specific purpose or purposes.

In some implementations, the host device 108 can include also a communications interface to read sensor data and/or user input, transmit signals representative of automatically generated prompts and/or predictions to the user, and/or receive devices signals operable to control the sensors. It should be readily understood that transmitting user data, sensor data, prompts, responses to prompts, query, query responses, predictions, and/or the like between one or more components of the system 100 comprises causing transmission of corresponding signals that are indicative of the user data, the sensor data, the prompts, the responses to prompts, the query, the query responses, the predictions, and/or the like. For example, transmitting user data from the smart virtual assistant device to the host device can comprise causing a transmission of a signal that is representative of the user data. Receiving the user data at the host device can therefore comprise receiving the signal that is representative of the user data. Similarly, transmitting automatically generated prompts and/or predictions from the host device to the smart virtual assistant device can comprise causing a transmission of a signal that is representative of the prompt and/or a signal that is representative of the prediction. Receiving the prompts and/or predictions at the smart virtual assistant device can therefore comprise receiving the signal that is representative of the prompt and/or the signal that is representative of the prediction.

In some implementations, various models generated and implemented by the host device, sensor data and user inputs from the users, and/or the matrix, intelligence matrix, etc. can be stored in a database 110.

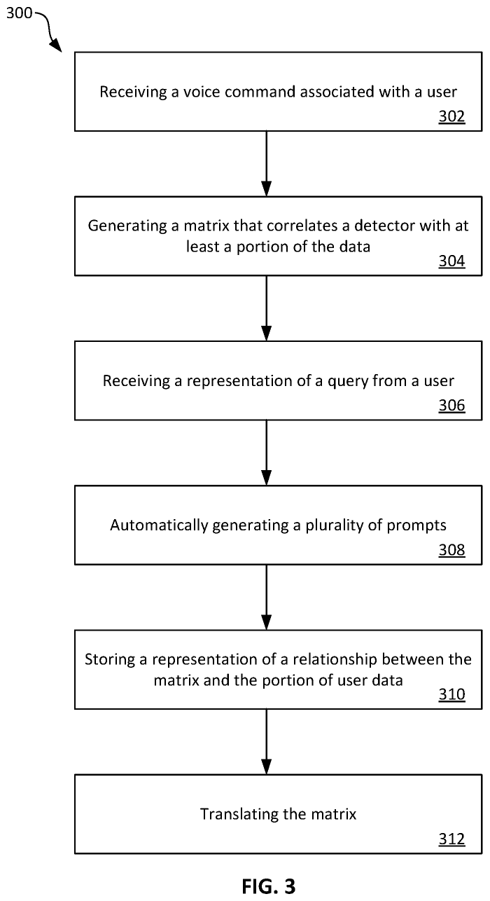

FIG. 3 is a flowchart illustrating a method 300 of using a self-automated map to automatically generate a query response. At 302, the method includes receiving a voice command associated with a user. For example, a user can interact with a smart virtual assistant device to provide a voice command. The voice command can include data that relates to a characteristic associated with an entity (e.g., person, object, place, etc.). For instance, the user data can include a birth date, birth time, birth location and/or the like of a person. Additionally or alternatively, the user data can include manufacturing date, manufacturing location and/or the like of an object. Similarly, the user data can include geographical coordinates of a place.

At 304, the method includes generating a matrix that correlates a detector with at least a portion of the data. For example, a host device can generate a matrix that correlates various detectors to various aspects of the entity based on the user input. Consider that the user provides a voice command that includes the birth date, birth time, and birth location of a person. The host device can correlate various detectors to aspects such as financial health, emotional health, physical health, career, etc. of the person.

At 306, the method includes receiving a representation of a query from the user. For example, the user can ask the smart virtual assistant a question regarding the person such as a question regarding the financial health of the person at a future time, a question regarding the physical health of the person at a future time, a question regarding changes that can occur to the person's career at a future time, etc.

At 308, the method includes automatically generating prompts for the user to respond. For example, the smart virtual assistant and/or the host device can automatically generate follow-up questions for the user. In some implementations, these follow-up questions can be dynamically generated based on a trained model (e.g., machine learning model, neural network, stochastic model, probabilistic model, and/or the like). The trained model can be generated on the host device and can be accessed by the smart virtual assistant as needed. Additionally or alternatively, these follow-up questions can be a pre-determined set of questions that are stored in a database and accessed by the smart virtual assistance and/or the host device as needed. The follow-up questions can include questions relating to the behavior of the entity so far. For example, the follow-up questions can be questions such as, for example, how the person handled a dire financial situation in the past, whether the person has any vices, whether the person had a medical emergency situation in the past, etc. These prompts can be provided as a voice prompt or a visual prompt. For instance, a speaker associated with the smart virtual assistant can ask these questions verbally. Additionally or alternatively, a graphical user interface associated with the smart virtual assistant and/or another compute device associated with the user can display the questions for the user to answer.

Once the user responds to these prompts various aspects of the entity can be rated based on the user response. For example, if the user responds by indicating that the person handled a dire financial situation by working hard and that the person has no vices, the aspect relating to financial health can be rated as high. However, if the user responds by indicating that the person had an emergency heart surgery in the past, the aspect relating to physical health can be rated as low.

The rating of the aspects can be used to generate relationships between various detectors and aspects of the person. For example, since the financial health aspect is rated as high, a detector that corresponds to financial health is also rated as high. Similarly, since the physical health aspect for the person is rated as low, a detector that corresponds to the physical health of the person is also rated as low.

At 310, the method can include storing a representation of a relationship between the matrix and the user data. For example, the host device can store the relationship between various detectors, the corresponding aspects, and their ratings. In some implementations, these relationships for the person can be stored in a database and accessed as needed.

At 312, the method can include translating the matrix. For example, the matrix can be updated based on the relationship between various detectors, the corresponding aspects, and their ratings. Consider that the detector corresponding to the person's financial health initially depicted that the person is going to face a dire financial situation in two year, since the detector corresponding to financial health of the person is rated as high based on the user's responses to the prompt, the matrix can be updated to indicate this rating. For instance, the matrix can be updated to represent that even in times of dire financial situation, the person can continue to maintain his or her financial health. Accordingly, translating the matrix can cause the smart virtual assistant to respond to the user's query. For example, in response to the question about the person's financial health in the future, the smart virtual assistant can respond by indicating that the person may maintain their financial health or continue to improve their financial health.

In some implementations, the method can further include collecting feedback to query responses can be used to update the matrix and/or update the trained model. Feedback can be collected from the users and/or sensors. For example, after two years if the person's financial health has significantly deteriorated, the user can provide feedback to the smart virtual assistant indicating that the query response was not necessarily correct. This can be used by the host device to update the matrix relating to the person. Additionally or alternatively, the host device can update the trained model. For example, the model can be updated to generate additional follow-up questions relating to the financial health aspect. For example, the model can be updated to generate additional questions that the user has to respond to such as, for example, the person's saving habit, the person's spending habit, etc. These additional follow-up questions can be help improve the prediction to user's questions at a future time.

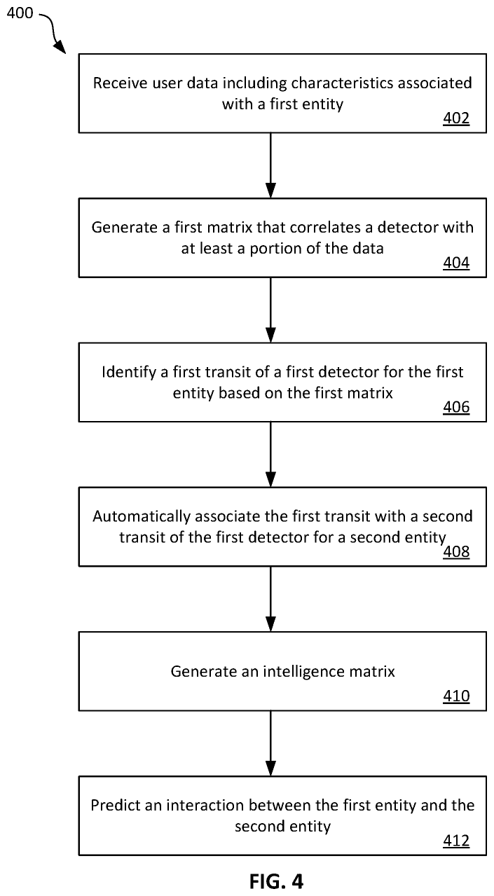

FIG. 4 is a flowchart illustrating a method 400 of automatically generating an intelligence matrix. At 402, the method includes receiving a voice command or a visual command from a user. For example, a user can interact with a compute device (e.g., smart phone, laptop, desktop, smart virtual assistant device, and/or the like) to provide a voice command or a visual command. The voice or visual command can include data that relates to a characteristic associated with an entity (e.g., person, object, place, etc.). For instance, the characteristic could be the birth time, birth date, birth location, and/or the like of a first person.

At 404, the method includes generating a matrix that correlates a detector with at least a portion of the data. For example, a host device can generate a matrix that correlates various detectors to various aspects of the entity based on the user input. Consider that the user provides a voice command that includes the birth date, birth time, and birth location of a first person. The host device can correlate various detectors to aspects such as financial health, emotional health, physical health, career, etc. of the first person.

At 406, the method includes calculating a first transit of a detector for the first entity for a given time duration based on the matrix. For example, each detector can transit through various detector locations as time passes by. The matrix can be used to locate a position of the detector. Accordingly, the host device can calculate the transit of the detector for a given time duration based on the matrix.

At 408, the method includes automatically associating the transit of the detector for the first entity with that of a transit of the detector for a second entity. For example, the second entity can have another matrix that correlates various detectors to various aspects of the entity. The same detector corresponding to the same aspect can be in different positions in the matrix for the first entity (e.g., first person) and the matrix for the second entity (e.g., second person). Accordingly, for a given time duration, the transit of the same detector can be different for the first person and for the second person. For the given time duration, the transits of the detector for the first person and the transits of the detector for the second person can be associated.

For example, consider a detector that corresponds to the financial health for the first person. The transit of the detector through various time durations for the first person based on the matrix for the first person can provide an indication of the future financial health of the first person. The same detector can correspond to the financial health for the second person. The transit of the detector through various time durations for the second person based on the matrix for the second person can provide an indication of the future financial health of the second person. For a given time duration, the financial health of the first person and the financial health of the second person can be associated. For instance, if the financial health of the first person for the given time duration is supposed cause a transition from medium health to high health and the financial health of the second person for the given time duration is supposed to cause a transition from medium health to low health, the detector corresponding to financial health can be associated to indicate a medium to high transition for the first person and a medium to low transition for the second person.

At 410, the method includes generating an intelligence matrix based on the association. For instance, the host device can generate the intelligence matrix based on the association between the transit of the detector for the first person and for the second person. For the example discussed above, the intelligence matrix can include a representation that indicates that the detector corresponding to financial health is medium-high for the first person for the first duration but medium-low for the second person for the same first duration.

At 412, the method includes predicting an interaction between the first entity and the second entity based on the intelligence matrix. For instance, the host device can determine whether the first person and the second person will interact in the future during the first duration. For example, since the first person's financial health goes from medium to high, and the second person's financial health goes from medium to low, the host device can predict that the first person and the second person may interact so that the first person financially helps out the second person.

In some implementations, method 400 further includes correlating the detectors to patterns at various time points. Accordingly, method 400 further includes predicting motifs of behavioral patterns for entities at various time points. For example, if the entity is transportation and a first detector is representative of the mode of transportation, then the patterns for the first detector can be representative of the type of mode of transportation at different time points. For example, time points in the 1800s can be correlated to horses, time points in the 1900s can be correlated to cars. In predicting a crash for a person in the year 2070 based on the intelligence matrix, the method 400 can also include the mode of transportation (e.g., motif of pattern) on which the crash might take place. In some implementations, similar to FIG. 3, the method 400 can further include obtaining feedback from the user and/or sensors.

Some embodiments described herein relate to methods. It should be understood that such methods can be computer-implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
receiving, at a processor and via a graphical user interface (GUI), input data including a representation of at least one behavioral pattern;
correlating, via the processor, the at least one behavioral pattern to pattern data associated with a set of detectors from a plurality of detectors;
generating a first matrix for a first point in time based on the correlation between the at least one behavioral pattern and the pattern data associated with each detector from the set of detectors, the first matrix including at least the set of detectors;
generating a plurality of interactive objects for presentation via the GUI, each interactive object from the plurality of interactive objects associated with the set of detectors from the plurality of detectors;
in response to detecting a user interaction with at least one interactive object from the plurality of interactive objects, defining and storing a representation of a relationship between each detector from the set of detectors in the first matrix and the input data;
transforming the first matrix based on the relationship, to define a transformed matrix; and
synthesizing the transformed matrix to generate a motif of the behavioral pattern of the input data; and
causing display of the motif of the behavioral pattern via the GUI.

2. The method of claim 1, wherein the correlating the at least one behavioral pattern to the pattern data is based on a spatial position of each detector from the set of detectors at the first point in time.

3. The method of claim 1, wherein the input data includes at least one of a birth time, a birth date, or a place of birth.

4. The method of claim 1, wherein the input data includes at least one of a birth time, a birth date, and a place of birth.

5. The method of claim 1, wherein the input data is a first input data, the at least one behavioral pattern is a first at least one behavioral pattern, and the set of detectors is a first set of detectors, the method further comprising:
receiving, at a processor and via the GUI, a second input data including a representation of a second at least one behavioral pattern;
correlating, via the processor, the second at least one behavioral pattern to pattern data associated with a second set of detectors from the plurality of detectors; and
generating a second matrix for the first point in time based on the correlation between the second at least one behavioral pattern and the pattern data associated with each detector from the second set of detectors, the second matrix including at least the second set of detectors,
wherein at least one detector from the first set of detectors is different from at least one detector from the second set of detectors.

6. The method of claim 1, wherein each detector from the set of detectors is associated with a parameter from a plurality of parameters and an area of operation from a plurality of areas of operation, the pattern data being a combined representation of the plurality of parameters and the plurality of areas of operations.

7. The method of claim 1, wherein the generating the plurality of interactive objects is based at least in part on a plurality of parameters, each parameter from the plurality of parameters being associated with a detector from the set of detectors.

8. The method of claim 1, wherein translating the first matrix includes replacing at least one detector from the set of detectors in the first matrix with at least a portion of the input data based at least in part on the relationship between each detector from the set of detectors in the first matrix and the input data.

9. The method of claim 8, wherein the synthesizing the transformed matrix includes determining a degree of interaction between the at least the portion of the input data and at least a further at least a portion of the input data replacing a further at least one detector from the set of detectors in the transformed matrix.

10. The method of claim 9, wherein the motif of the behavioral pattern includes a representation of the degree of interaction between at least the portion of the input data and at least the other portion of the input data.

11. A method of automatically generating a query response to a query from a user, the method comprising: receiving, at a processor, a representation of a voice command including user data detected via a microphone, the voice command associated with a user;
in response to the user data, generating, via the processor, a first matrix that correlates a location for a first detector from a plurality of detectors at a first time with at least a portion of the user data;
receiving, at the processor, a representation of a query from the user, in response to at least one of a voice input or a visual input;
automatically generating, via the processor and based at least in part on the query, a plurality of prompts, each prompt from the plurality of prompts including one of a voice prompt or a visual prompt;
causing presentation of the plurality of prompts to the user via at least one of a speaker or a graphical user interface (GUI);
in response to detecting at least one user response to the plurality of prompts, storing a representation of a relationship between the first matrix and the at least the portion of the user data based at least in part on the at least one user response; and
translating the first matrix, thereby generating a query response to the query from the user.

12. The method of claim 11, wherein the user data includes at least one of a birth time, a birth date, or a place of birth.

13. The method of claim 11, wherein the user data represents a pattern, the method further comprising:
obtaining, at the processor, sensor data from at least one sensor, the sensor data associated with the pattern represented by the user data.

14. The method of claim 13, further comprising:
updating the first matrix based at least in part on the sensor data obtained from the at least one sensor.

15. The method of claim 11, further comprising:
obtaining, at the processor, a representation of a feedback from the user to the query response generated via the processor in response to the query, the feedback being at least one of another voice input or another visual input.

16. The method of claim 15, further comprising:
training, via the processor, a machine learning model based at least in part on a comparison between the feedback to the query response and the generated query response, the machine learning model being configured to generate the first matrix.

17. The method of claim 16, further comprising:
updating the first matrix based at least in part on the comparison between the feedback to the query response and the generated query response.

18. The method of claim 16, wherein the user data is a first user data, the method further comprising:
receiving, at the processor, a representation of another voice command including a second user data detected via the microphone; and
generating the first matrix, via the processor and by executing the machine learning model, the first matrix further correlating another location for a second detector from a plurality of detectors at a second time to the second user data.

19. The method of claim 18, wherein the query is a first query and the query response is a first query response, the method further comprising:
receiving, at the processor, a representation of a second query from the user, in response to another voice input or another visual input;
storing a representation of a relationship between the first matrix and at least the portion of the second user data based at least in part on the execution of the machine learning model;
translating the first matrix; and
predicting a second query response to the second query.

20. The method of claim 11, further comprising:
causing presentation, to the user, of the query response to the query via at least one of the speaker or the GUI.

21. A method for predicting future interaction between two entities, the method comprising:
receiving, at a processor, a representation of a voice command or a representation of a visual command including user data, the voice command or visual command associated with a user, the user data including characteristics relating to a first entity;
in response to the user data, generating, via the processor, a first matrix that correlates a location for a first detector from a plurality of detectors at a first time with at least a portion of the user data including characteristics relating to the first entity;
calculating first transits of the first detector from the plurality of detectors for a first time period based at least in part on the first matrix, the first transits of the first detector being for the first entity;
automatically associating the first transits of the first detector for the first entity with second transits of the first detector for a second entity for the first time period, the second entity being associated with a second matrix that correlates the location for the first detector with characteristics relating to the second entity;
generating an intelligence matrix associating the first transits of the first detector for the first entity with second transits of the first detector for the second entity; and
predicting an interaction between the first entity and the second entity during the first time period based at least in part on the intelligence matrix.
